(19) United States
(12) Patent Application Publication
(10) Pub. No.: US 2011/0234779 A1
(43) Pub. Date: Sep. 29, 2011

(54) Remotely controllable photo booth with interactive slide show and live video displays

(76) Inventor: Allen Weisberg, Greenvale, NY (US)

(21) Appl. No.: 12/932,712

(22) Filed: Mar. 3, 2011

Related U.S. Application Data
(60) Provisional application No. 61/339,662, filed on Mar. 5, 2010.

(51) Int. Cl. H04N 7/18

(52) U.S. Cl. 348/61; 348/E07.085

(57) ABSTRACT

An advanced photo booth comprises a camera, a kiosk printer; and attraction means for inducing patronage of passers-by. The attraction means comprises: a camera and a touch screen for capturing and displaying passerby images; and interactive communication with passers-by. Interactive communication may include personalized greetings made possible through facial recognition techniques that compare a presently captured passerby image with previous passerby and patron images stored in a memory. Digital image processing techniques automatically permit proper tilting of a head in the display screen, regardless of a head position in captured passerby images. The attraction means also comprises a second exterior display screen usable for advertising and CATV broadcasts. The passerby touch screen or a touch screen display within the enclosure permits customization of digital images, including: face replacement, hair replacement, and background selection; and also permits previewing of customized images. Remote control capabilities enhance the flexibility of booth operations.

### CROSS REFERENCES TO RELATED APPLICATIONS

This application claims priority on U.S. Provisional Application Ser. No. 61/339,662, filed on Mar. 5, 2010, the disclosures of which are incorporated herein by reference.

### FIELD OF THE INVENTION

The present invention relates to improvements in automated photography booths, and more particularly to systems, methods, and apparatus which expand and improve the functionality and variety of products available from such booths, and more particularly to apparatus and systems which provide an automated kiosk approach to attracting customers.

### BACKGROUND OF THE INVENTION

The vending business within the United States is a growing and evolving source of revenue. In 2008, automatic vending machine revenue was a billion dollar industry, and had experienced an increase over the estimated 2007 sales. Although the lion's share of the market is occupied by machines which sell snacks and candies, and the, complementary vended product of soft drinks, opportunity for diversification and further sales through innovative ideas and marketing is apparent. While there has been a steady decline in video rental profits at the nation's largest chains and other stores, due to very inexpensive sales of videos at retailers as well as on-demand cable movies, $1 rentals at DVD vending machines soared in 2009.

Not unlike the out-of-date business model for video rental stores, the automated photo booth vending machine has seen more profitable days. One of the first of such automated photo booths was the Photomaton Studio, which was opened to the public in 1925 by Anatol M. Josepho on Broadway in New York City. It would receive thousands of patrons per day, who were willing to pay 25 cents for a strip of eight black and white photographs. U.S. Pat. No. 1,656,522 was granted to Josepho in 1928 for the process used for developing the film strips for the automated process.

The popularity of such automated photographic booths remained strong, and even entered popular culture, with a notable cinematic appearance in 1953, in the Fred Astaire/Cyd Charisse film, “The Band Wagon,” where Astaire performs a number while dancing into and out of a Photomatic. Popularity grew with use by Andy Warhol for photographic projects for Harpers Bazaar and Time Magazine in the 1960s.

Ironically, despite the introduction of digital color photo booths in the 1990s, such as the one described in U.S. Pat. No. 5,587,740 to Brennan for a “Digital Photo Kiosk,” black and white photo booths retain a fair portion of the market share in the U.S., whereas they have been mostly replaced in Europe by color photo booths. However, their overall usage is significantly lower in the U.S. than in other countries, such as Japan, France and the United Kingdom, where in addition to providing amusement, they are commonly utilized for passports, driving licenses, and other forms of identification. The amusement factor has diminished within the U.S. in part due to the proliferation of compact digital still cameras, and the inclusion of a digital photographic capability within cell phones.

Innovative changes in photo booths have not matched the rapid pace of developments within the electronics industry. U.S. Pat. No. 6,619,860 to Simon discloses the use of a monitor to attract patrons walking past the booth; however, it is extremely limited in that it merely comprises the monitor showing a painting of a person being generated in the same way that is accomplished within the Simon device. U.S. Pat. No. 6,523,034 to Hoyt, for a “Method For Increasing Traffic on an Electronic Site of a System of Networked Sites,” discloses a process that permits selection of electronic background themes by way of a touch screen, and further provides for storage of the purchased photographs on an internet web-site, that may be accessed using a password delivered to the purchaser at the kiosk. The Hoyt device does allow for personalization by a user, but only to the extent of being able to enter a title using a keyboard.

Other features were disclosed in U.S. Pat. No. 7,212,308 to Morgan for an “Interactive Photo Kiosk.” The Morgan device discloses a hardware and software capability to permit the user to manipulate the captured image through the use of various scenic backgrounds, as well as an option for backgrounds of pre-imaged aesthetically pleasing people in suggestive poses. The Morgan device further provides for the display of the image of a person standing in front of the kiosk, along with advertising, as well as displaying the image of the user within the kiosk.

Despite the addition of these features, there are some inherent deficiencies of all prior art devices which limit usage by many members of the purchasing public. There are also many other novel options disclosed herein to improve the current state of automatic photo booths.

### OBJECTS OF THE INVENTION

It is an object of the invention to provide a photo system that attracts costumers by means of an interactive communication means between a photo booth and one or more passersby.

It is also an object of the invention to provide an improved photo booth that attracts potential costumers by providing sample photographs of a passerby and thereby enticing the passerby to enter into a sale transaction.

It is an object of the invention to provide an improved photo booth whereby the booth may interact with a passerby without the passerby manually activating the booth.

It is a further object of the invention to provide a user with a variety of poses processed from a single image of the user.

It is still a further object of the invention to provide a user with a variety of sample poses from a single image of the user without manual input by the user.

It is still a further objective of the invention to provide a user with a means for purchasing a variety of poses from a single image.

It is another object of the invention to provide a photo booth with a means to recognize that a person is in the vicinity of the photo booth and distinguish that person from a second person in the vicinity of the photo booth without manual interaction with any persons in the vicinity of the photo booth.

It is still another object of the invention to provide a photo booth that has the ability to recognize that a person is in the vicinity of the photo booth and when that person is out of range of such booth cease to interact with such person.

It is a further object of the invention to provide a photo booth that has the ability to recognize that a person is within range of the photo system and that when such person returns within the range of the photo system after stepping away from the system, the system recognizes the person as having been within range before.

It is a still further object of the invention for the system to address a passerby as a new visitor or a returning visitor.

It is an additional object of the invention to provide a means of upgrading existing photo booths with digital effects options.

It is still an additional object of the invention to provide a means of enticing passersby to experiment with the digital effects possible with the booth of the current invention.

It is a further object of the invention to provide a means of enticing passersby to use the photo booth and pay for a digital photo record selected by a user from a large number of possible poses and backgrounds.

It is another object of the invention to provide a means of externally displaying on the booth special effects offered by the photo booth.

It is a further object of the invention to provide a means of instantly printing or e-mailing the photographic output.

It is another object of the invention to provide a means of electronically sending the photographic output to online social networking sites.

It is also an object of the invention to provide a means of attracting English-speaking and non-English-speaking customers.

### SUMMARY OF THE INVENTION

A device of the current invention is an advanced photo booth which offers both the owner and the patron more options and possibilities than have previously been available. The device herein features at least an external monitor, at least one capturing means for recording an image of a user, and a payment means for permitting the user to purchase a product of the system. The present invention uses at least one camera, preferably an exterior camera, and face tracking technology to capture the image of persons walking past, and to rapidly manipulate the image on screen to attract the person's attention, and alert the potential customer to the various different photo options that are available in the booth. By the term photo booth is meant a means for capturing an image of a person, a means for displaying the image, and a means for such person to purchase the image. The booth may be an external arrangement or it may include a private area where a user may have one or more pictures taken. The booth may also be a combination of the two arrangements.

The photo system of the present invention attracts costumers through an interactive communication means between a photo booth and one or more passersby. The system can attract potential costumers by providing sample photographs of a passerby and thereby entice the passerby to enter into a sale transaction at the photo booth. One of the key features of the present invention permits the booth to interact with a passerby without the passerby manually activating the booth. Using the system a user is provided with a variety of poses processed from a single image of the user. These sample poses can be provided from a single captured image of the user without manual input by the user. The user is provided with a means for purchasing one or more poses from a single image or if desired there may be multiple takes if the initial picture is not satisfactory. The user can purchase one or more of the shots.

The photo booth is provided with a means to recognize that a person is in the vicinity of the photo booth and to distinguish that person from a second different person in the vicinity of the photo booth without manual interaction with any persons in the vicinity of the photo booth. The photo booth also has the ability to recognize that a person is in the vicinity of the photo booth and when that person is out of range of such booth cease to interact with such person.

In addition, the photo booth has the ability to recognize that a person is within range of the photo system and that when such person returns within the range of the photo system after stepping away from the system, the system recognizes the person as having previously been within range of the system previously.

The interactive aspect of the system permits the photo booth to vocally address a passerby and enter into a colloquy with the user to entice the user to make a purchase. The system can address the user differently as either a new visitor or a returning visitor.

The options within the booth may include both color, and/or black and white output onto strips of multiple photos, or 4×6 prints, or into passport sized photo prints. The term color can include a monochromatic instance of color or multiple colors up to a full color image. The present invention may include repeated snapshots of the patron until a satisfactory image is obtained, or the device may take a single picture of the user and manipulate the image to produce a variety of representations of the user. For example, the invention may comprise face replacement onto other people's bodies, other hairstyles, and/or a multitude of backgrounds. The device may permit a filtering option to allow more suggestive options for adults. Backgrounds may include holiday scenes, religious backgrounds, and specialized themes for various groups such as the military or sporting teams. A special option may permit superimposing the photo taken in the booth onto a scene from around the word to output a postcard. A screen may be usable both as a touch screen to choose from available options, as well as like a tablet PC, where a pen or stylus means permits the patron to add custom annotations to the photographic output by writing on the screen.

The device may also feature internet capabilities to serve the patron and the kiosk owner. The patron may have the photographic output sent to his email address, or thereby interact with social networking sites, such as Facebook and Twitter. The owner may be able to monitor the kiosk remotely over the internet as to supplies needed, proper functioning, and even sales performance. The owner may also remotely upgrade the features of the booth or add backgrounds, and change prices or special promotions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a front view of a first embodiment of the photo booth of the present invention.

FIG. 1A is a front view of an alternate embodiment of the photo booth of the present invention.

FIG. 2 is a photograph showing a perspective view of the photo booth of the present invention, with the entry door opened, and with the booth operator remotely controlling the booth over the internet using a cell phone.

FIG. 2A is a photograph showing the photo start button of the present invention that may be located on the outside of the photo booth.

FIG. 3 is a perspective photographic view of the photo booth front access panel opened to reveal the booth's electronics.

FIG. 4 is a view of the main menu configuration options of the present invention, with the “camera setting” button selected.

FIG. 5 is a view of the main menu configuration options of FIG. 4, but with the “face detection” button selected to reveal the options therein.

FIG. 6 is a view of the main menu photo booth options, with the “fun borders” button selected to reveal the options (on/off) therein.

FIG. 7 is a view of the main menu program options, with the “fun borders” button selected to reveal the options (on/off) therein.

FIG. 8 is a screen shot showing portrait images of a patron in the photo booth being generated on the interior monitor, and with options for purchasing the portraits in different size formats.

FIG. 9 is a screen shot showing I.D. photo images being generated on the interior monitor for a patron within the photo booth.

FIG. 10 is a screen shot showing the border options available for photographic images generated for patrons of the photo booth.

FIG. 11 is a screen shot showing the post card options available for photographic images generated for patrons of the photo booth.

FIG. 12 is a screen shot showing the face replacement options available for photographic images generated for patrons of the photo booth.

FIG. 13 is a screen shot showing the hair style replacement options available for photographic images generated for patrons of the photo booth.

FIG. 14 is a block diagram of the options available within the software of the present invention under the user interaction module.

FIG. 15 is block diagram of the purchasing process for the photographic output of the present invention, within the shopping cart module.

FIG. 16 is block diagram of the portrait options within the portrait module of the present invention.

FIG. 17 is a block diagram of the post card creation process of the present invention under the post card module.

FIG. 18 is a block diagram of the identification photo creation process of the present invention under the Photo I.D. module.

FIG. 19 is a block diagram of the overall process in the Image Selection module.

FIG. 20 is a block diagram of the process of hair replacement in the present invention in the Hairstyle Module.

FIG. 21 is a block diagram of the process of face replacement in the present invention in the Hairstyle Module.

FIG. 22 is a block diagram of the process of face recognition in the present invention.

FIG. 23 is a block diagram of the process of face detection in the present invention.

FIG. 24 is a block diagram of the process of overlaying a border on a captured image within the present invention.

FIG. 25 is a block diagram of an exemplary computer system.

FIG. 26 is front view of a tablet and stylus for entering personalized text and graphics onto a captured image, within the present invention.

### DETAILED DESCRIPTION OF THE INVENTION

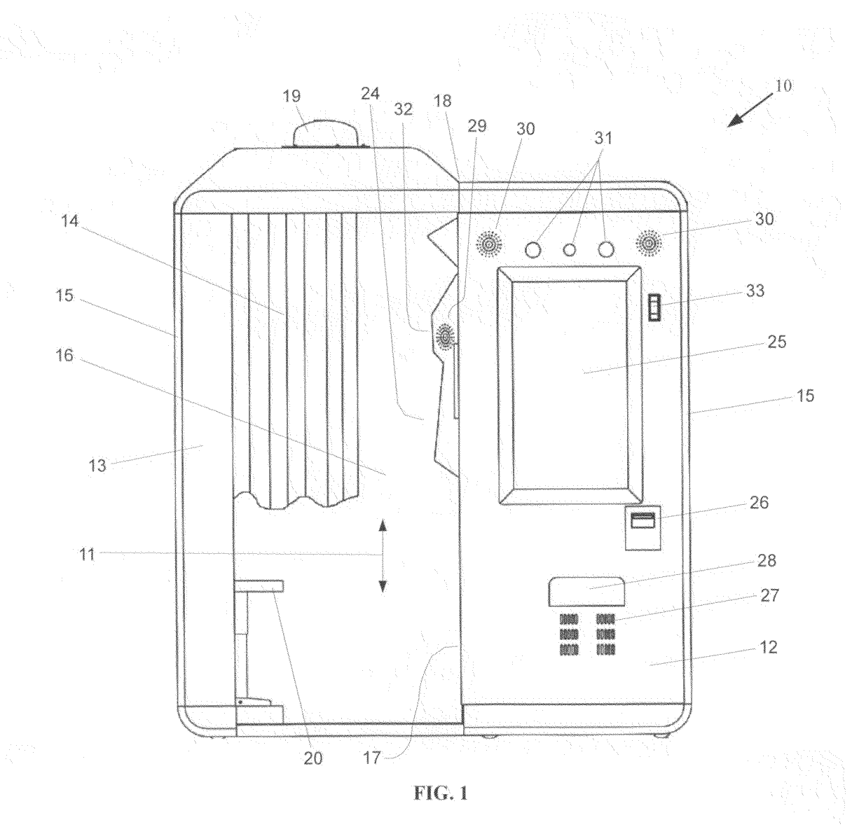

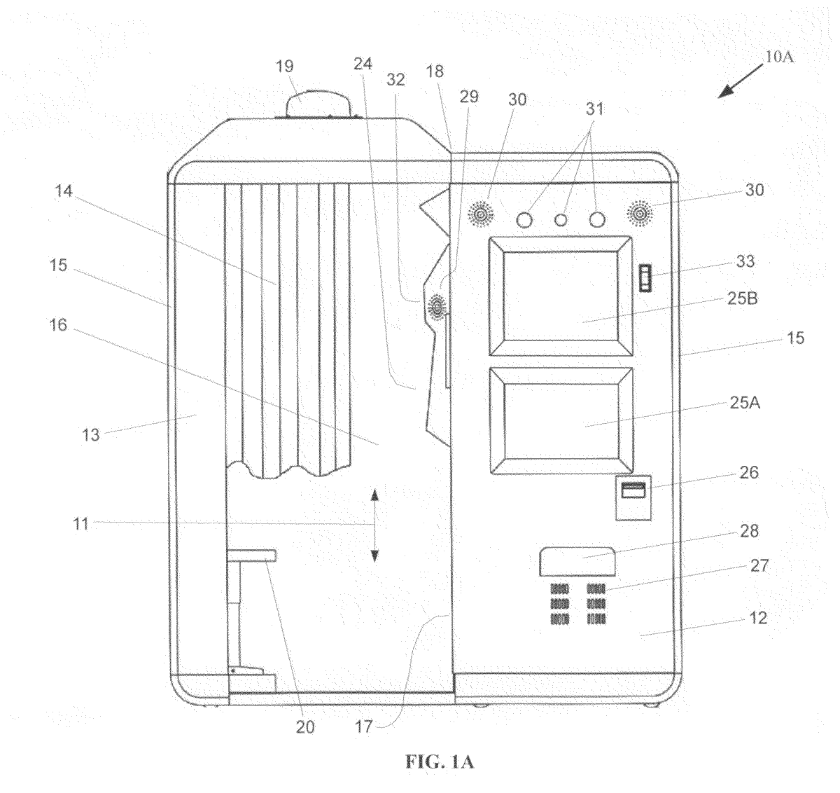

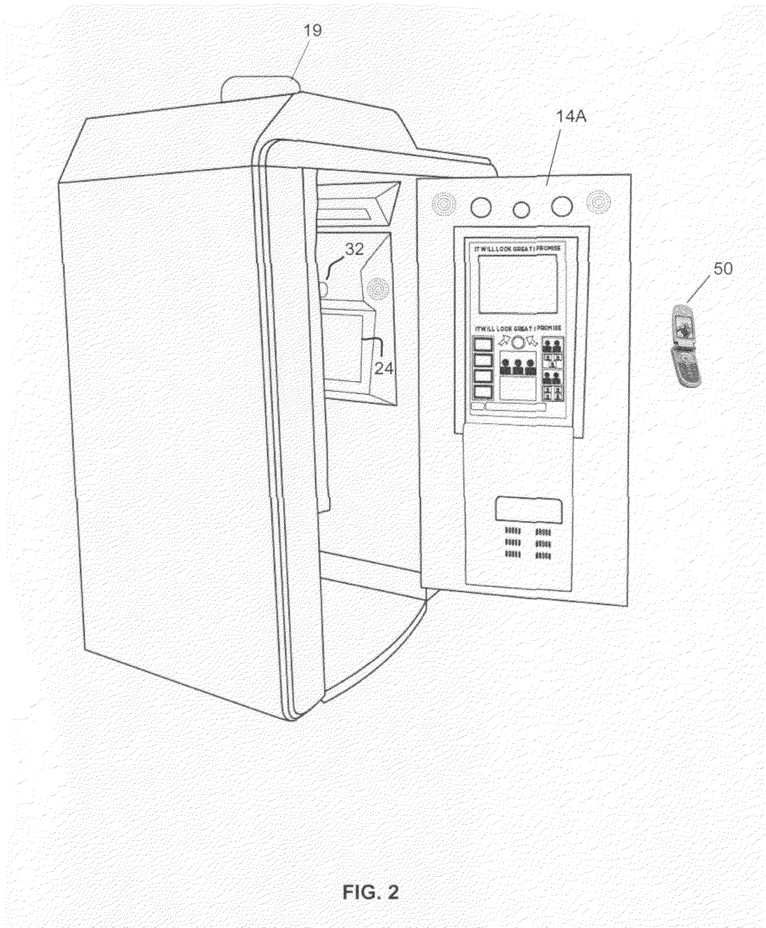

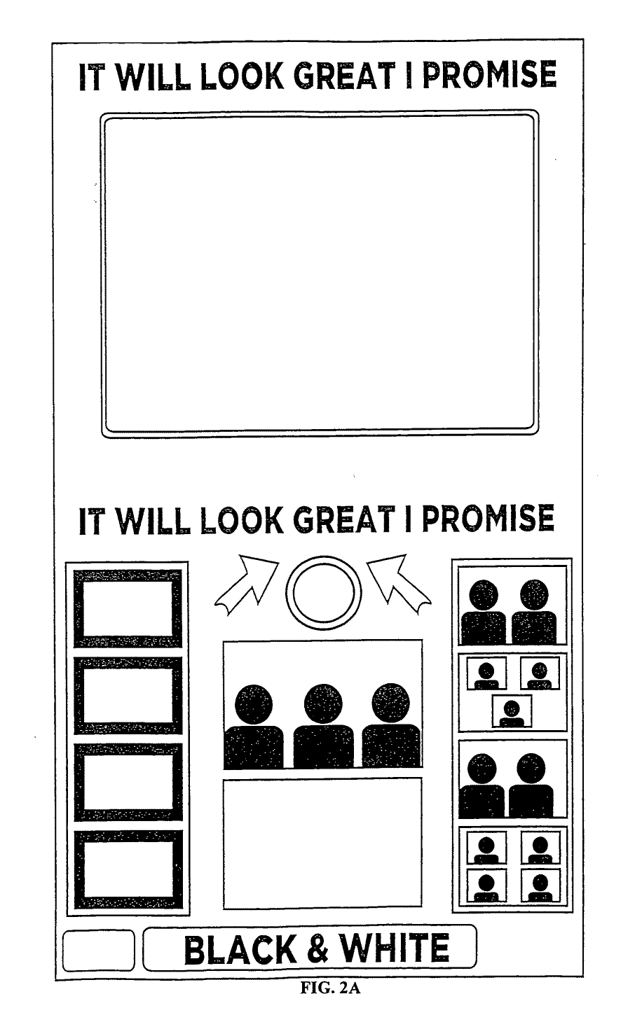

The photo booth of the current invention, as seen in a first embodiment in FIG. 1, may have an enclosure forming an interior, and having exterior surfaces. The photo booth 10 may be comprised of a front main wall 13, side walls 15, a rear wall 16, and a roof wall 18. There may also be a dividing wall 17 between the side walls 30 to serve to divide the booth and create the booth interior 11, which may have a bench 20 therein, and an adjacent compartment for storing the electronic and other components of the photo booth. The adjacent compartment may be enclosed by a hinged front access panel 12, which may be secured using a door latch and lock 35. The separation between the end of the front wall 13 and the dividing wall 17 is usable as an opening into the interior 11, and may have a traditional curtain 14 (FIG. 1) attached thereto, or a solid door 14A (FIG. 2), which may afford greater privacy for booth users and may also improve the lighting for the digital photographic experience. The roof wall 18 may have contouring as required for entry of a taller person, and may be equipped with a strobe light 19 or other light fixture atop the roof wall 18 to attract attention to the photo booth 10, as described hereinafter.

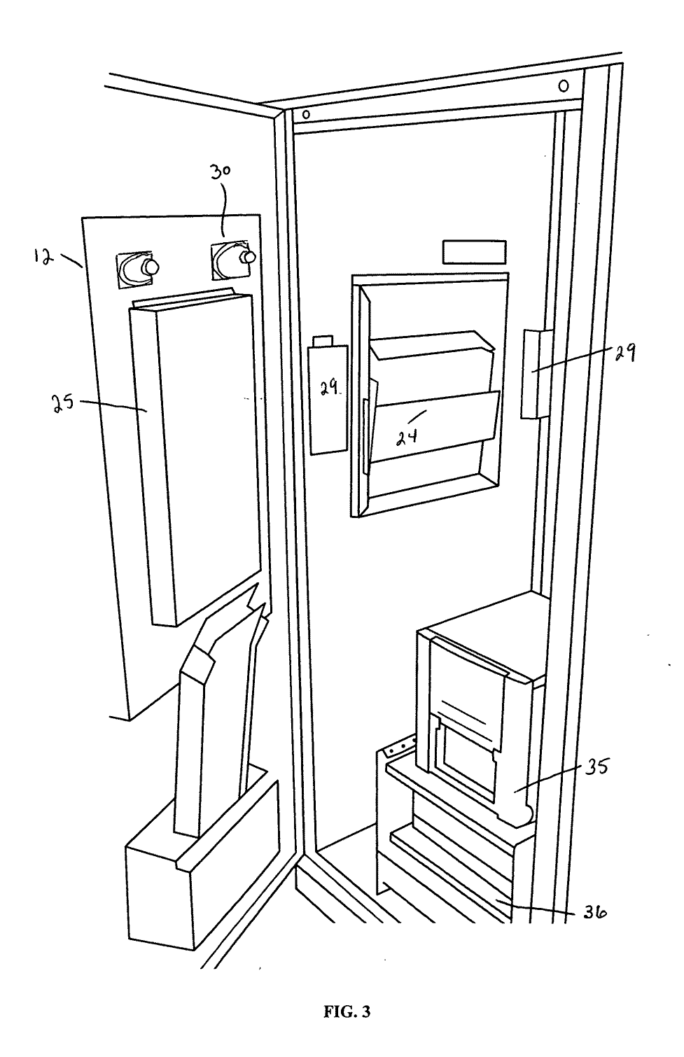

As seen in FIG. 3, the front access panel 12 may pivot to reveal the equipment compartment. Access panel 12 may be hinged at one end, and be screwed into place at the opposite end, or it may be secured at the opposite end using a keyed locking device. The panel 12 permits access to the electronic equipment of the present invention, which may include a central processing unit (CPU) 36 being electrically coupled to the LCD display monitor 25 which faces the exterior of the booth, and which is mounted to the panel 12. The CPU 36 may also be coupled to an interior LCD monitor 24 which faces the interior 11 of the booth, as well as being coupled to interior and exterior speakers 29 and 30, and to one or more digital printing devices, for delivery of photographic output to a delivery area, such as print chute 28 in the front access panel 12. The CPU 36 may preferably be capable of running commercial software packages to achieve the image processing techniques described herein, including software such as, for example, Adobe® Photoshop®.

The display screens of the present invention may preferably be a touch screen monitor, such as a 32 inch monitor manufactured by 3M Company, and may include a corresponding CATV connection to display news, sports, or other broadcasts, which may also provide a means of enticing potential customers to gather around the booth. While the person may be standing in front of the booth to catch the score of a game, or hear breaking news, the person's image may be displayed and manipulated above the broadcast, as described hereinafter to entice the viewer to become further engaged with the booth. Receipts and photographic output at the kiosk may be provided by one or more kiosk printers that are capable of printing images and/or text onto a substrate. Examples of such kiosk printers are the APU-9000 and the KPU-S347/447 series of printers made by Seiko Instruments USA, Inc, the Mitsubishi CP9550DW-S Dye Sub Photo Printer, which is capable of outputting standard photographic prints sizes, including 3.5×5, 4×6, 5×7, as well as the Mitsubishi CP3020DAE Photo Printer, which can output 8×10 and 8×12 prints.

The lower portion of front access panel 12 may also have one or more vent openings 27 for air in/outflow from an electrical equipment cooling fan. A portion of the front access panel 12 may incorporate one or more openings for exterior photographic cameras 31. The upper portion of the front access panel 12 may have one or more openings 30 to accommodate speaker output directed towards the potential customers walking past the booth. The speaker output may be music, or may be a product related sales pitch to draw one or more passers-by over to the booth, or it may be sound for the T.V. broadcast previously mentioned. The interior of the booth 11 may have a separate speaker system 29 to supply audio directions and product options to the current patrons of the photo booth 10, as well as an interior camera 32 to capture the images of patrons of the photo booth. A user option may permit display of the booth's interior touch screen options and images to appear on the exterior monitor, which may be appealing for a large group of friends who may thus share the photo booth experience simultaneously.

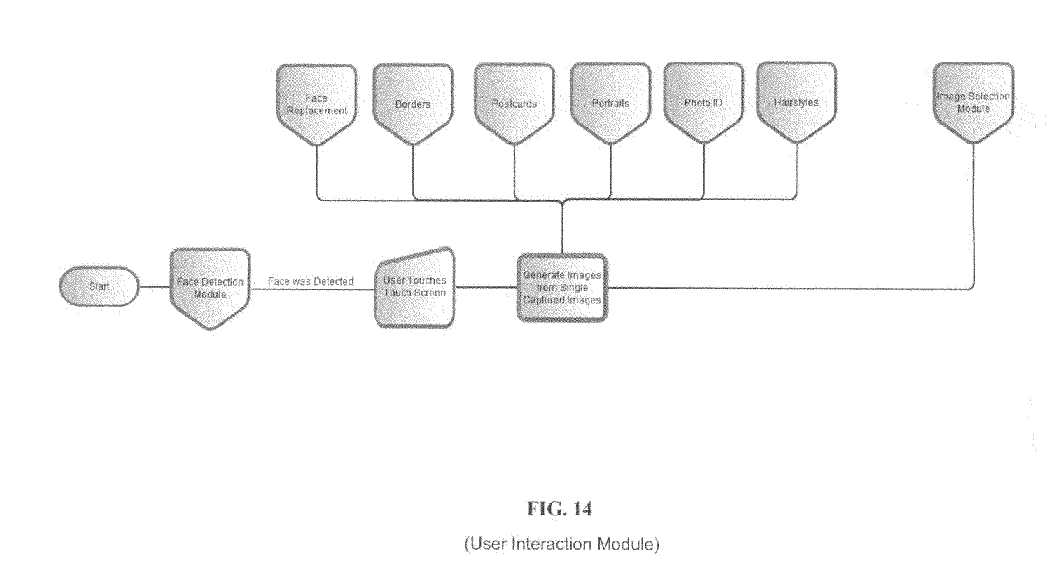

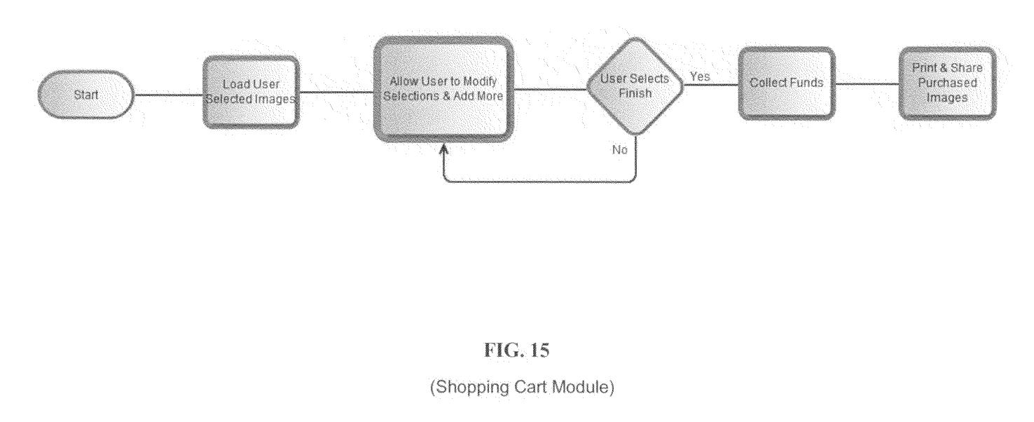

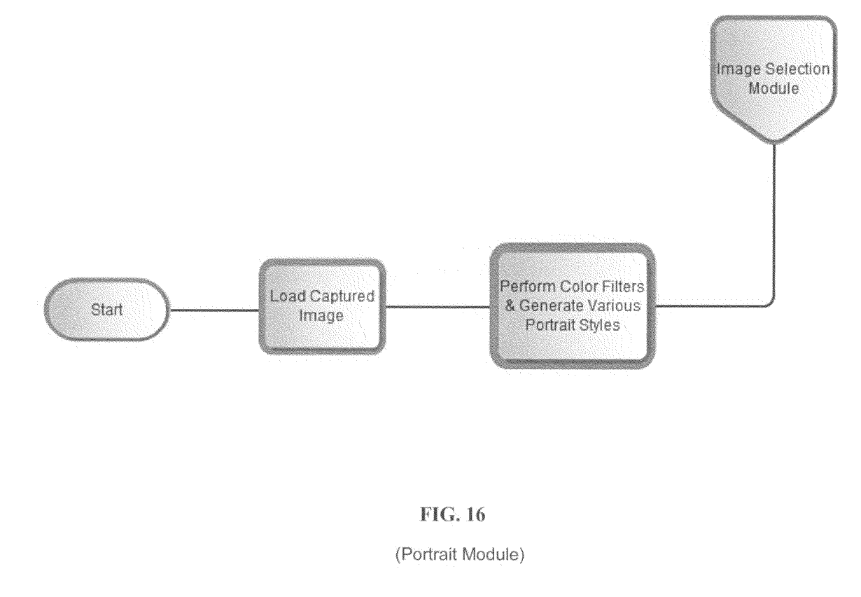

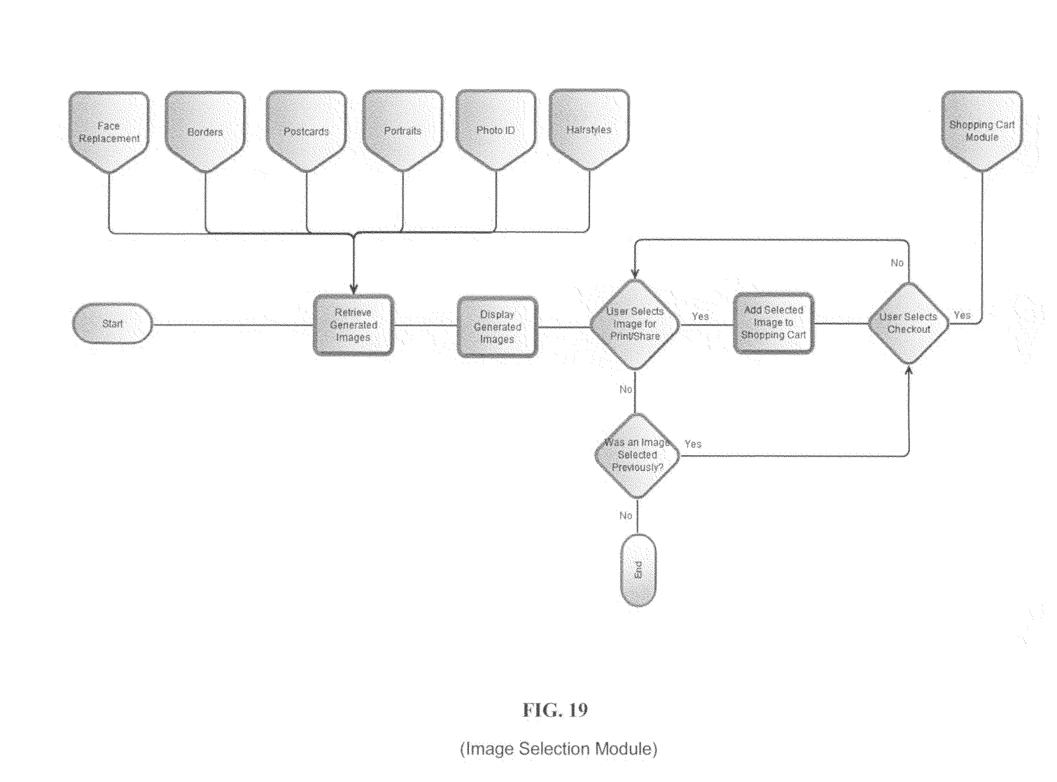

The photo booth of the present invention may comprise a variety of operating modes, as seen in the block diagrams of FIGS. 14-24. These modes will enable certain functionality within the photo booth and outside of the photo booth, as well as interaction therebetween. The exterior of the photo booth (FIGS. 1-2) of the present invention may offer a variety of attraction modes, in addition to decorative artwork, to entice customers walking past to explore the novel options now available to photo booth patrons of the present invention. The number of attraction modes may be unlimited, with additional modes being added to the software herein at a later date. The interactive attract mode of the present invention may permit interaction of the booth with the potential patron, without the person physically contacting the booth, except for the financial transaction.

The interactive attract mode has many novel features. It may employ motion detection and a camera for facial recognition, which may be connected to a central processing unit to provide artificial intelligence in the interaction process. The camera may be preferably a Sony camera. There may be an outside display screen 25 that may initially have the image of a woman or man talking to the patron. The images on the exterior display screen may be a still image, or may also be live or pre-recorded video of the person. The motion detection capability may determine if there is one, two, or even more potential customers entering the range of the photo booth, and greet them by enunciating a phrase, such as, “thank you for bringing your friend,” and may thus alert the patrons to the machine's awareness and ability to conduct interactive communications. If the potential customers walk away, the machine may detect the departure and respond by saying, “good-bye, hope to see you again soon.”

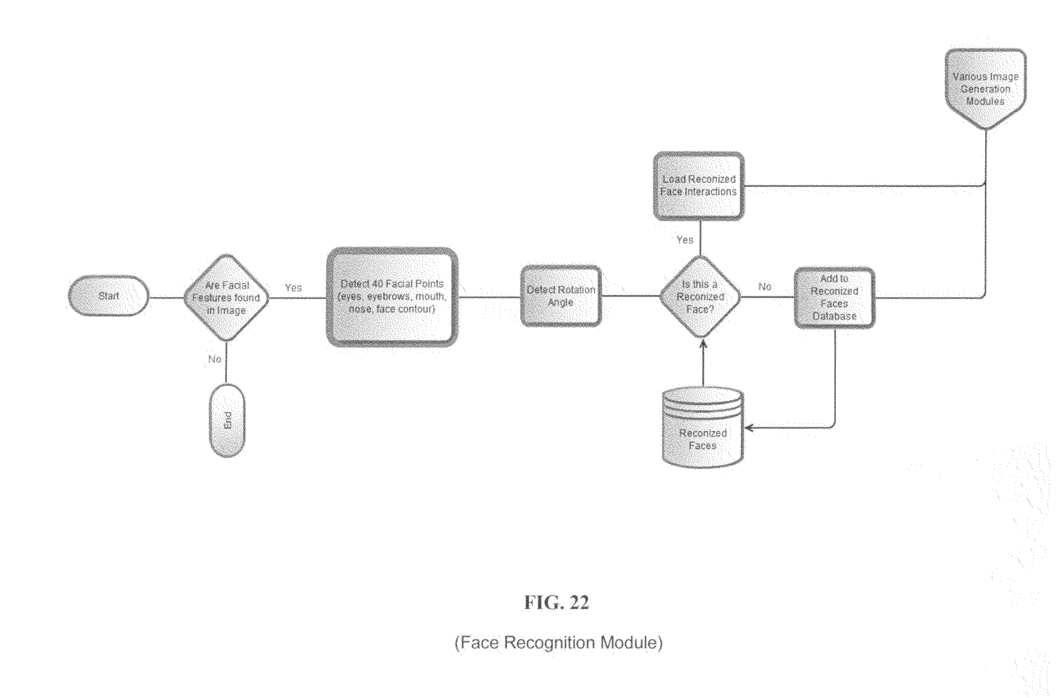

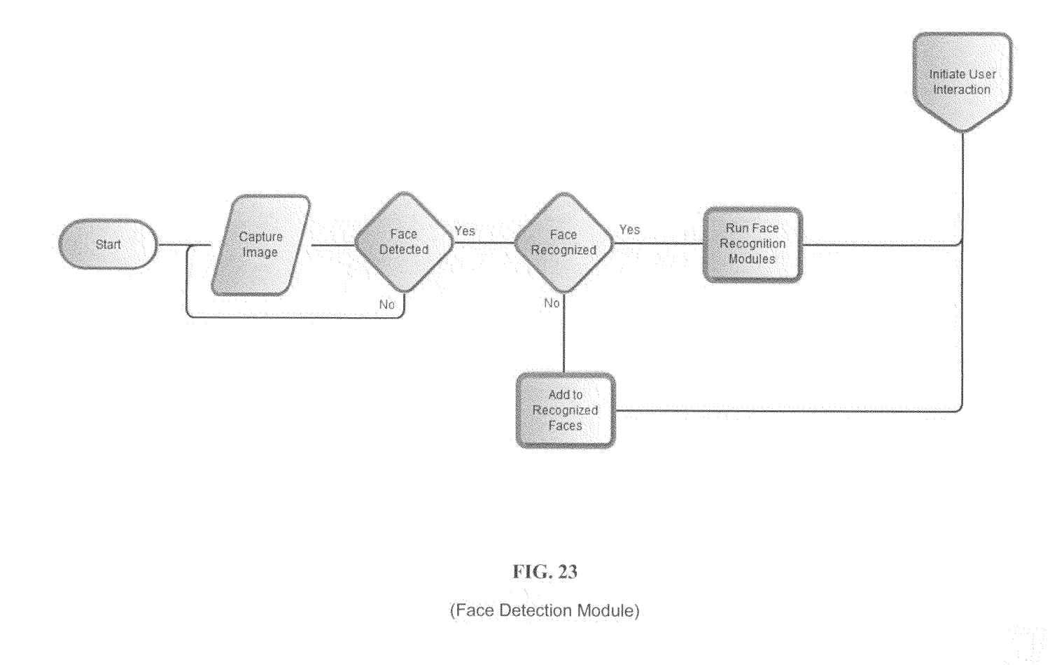

The artificial intelligence of the photo booth of the present invention begins with facial recognition capability utilized herein. The photo booth of the present invention utilizes a software development kit (SDK) that includes a Face Detection & Recognition Engine (available at: www.luxand.com/facesdk/, the disclosures of which are incorporated herein by reference), in conjunction with proprietary software modules to handle various interactions with patrons and potential patrons. The device will recognize previous customers and passersby, if they later return and re-enter within the range of the motion detector and image-capturing camera of the kiosk, as some 40 different facial points comprising their facial features may be stored in a memory for comparison to a present passerby (FIGS. 22 and 23). When a previous customer or passerby is recognized, the photo booth may offer an appropriate, personalized greeting, such as, for example, “thank you for coming back.” Although these features and others disclosed herein are directed to a photo booth, they may similarly be utilized on a juke box to attract customers to make selections on a touch screen of a juke box. Other interactive communication may be in the form of providing progressive aural and/or textual directions to a patron seeking to use the photo booth, communicating product options, and communicating a sale pitch for the kiosk products at appropriate times of engagement by the passerby with the kiosk, such as, for example, when they first touch the display screen.

This image of a passerby may be captures an instantly appear on the outside display screen 25 to attract the person's attention. The software of the portrait face tracking feature herein also permits the users to occupy any position when photographed, and may nonetheless still properly display the image on screen and in photographic prints, which represents an improvement over the prior art that had required precise positioning of the subject for the photo to be properly inserted. The software herein automatically will properly orient or tilt the person's head on screen and within the processed image, even if the image requires an unusual position, such as being tilted at an angle, or if the person's head had been tilted at an angle when photographed. A captured image may be quickly manipulated on the exterior monitor 25 by the potential patron using the touch screen, which may simulate the options that the actual paying patron will be able to experience within the booth and may permanently capture on photo strips.

The attraction modes may also feature an option for the passerby to print a free picture, in which no money will be required or collected, but where little is given in the way of selectable options. The mode will nonetheless give potential patrons standing outside the booth a sample photograph to entice additional more personalized and compensated usage. The paying patron, being either outside or within the booth, will have greater interaction with the device and access to the full range of disclosed options. A means for the patron to make a payment- a currency acceptor 26- may be located both inside the booth and outside of the booth, and which may be capable of accepting payments in the form of cash and credit/debit cards. The exterior monitor may display a notice for the uncompensated outside printing of sample photos, such as “Free Mode: Printing.”

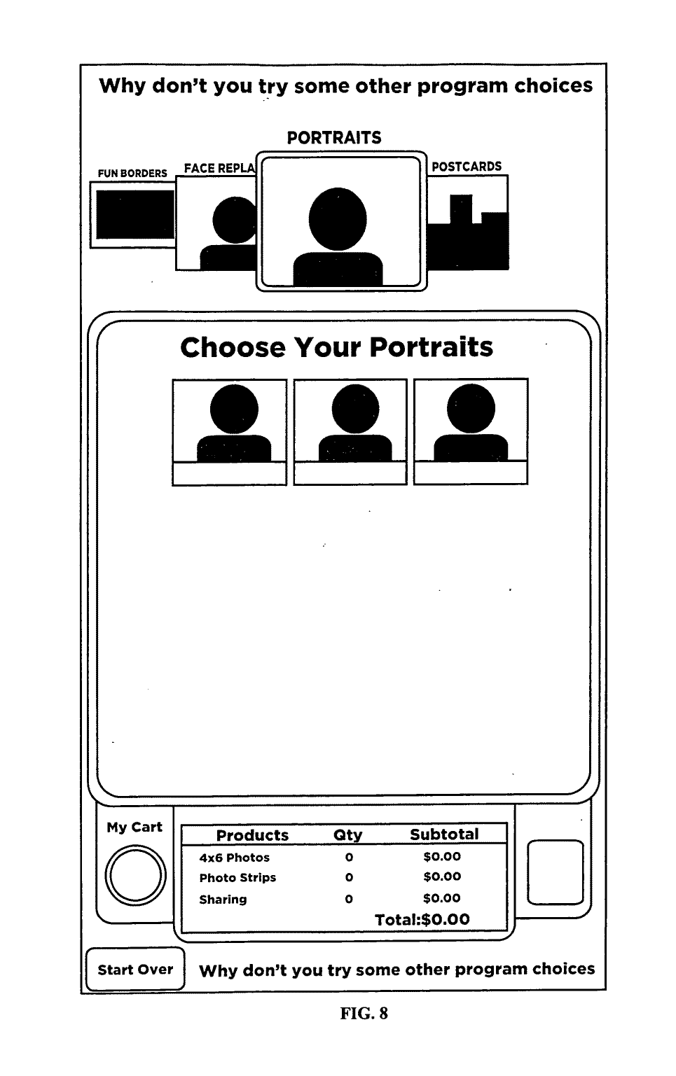

The device may place the captured image of the paying patron within the booth, onto the screen to preview the patron's appearance in either the four-photo strip and/or the 4×6 image (FIG. 8). There may be an option to preview both the photographic output size, and/or the color choice, being the choice to print either a colorized print, or alternatively, to print the traditional black and white photo booth prints. If the patron is not satisfied with the pose, the red button 33 (FIG. 2) may be pressed, and after a short lapse of time, another snapshot will be taken and displayed onto the screen, permitting the patron the option of choosing four unique poses for a four-photo strip, rather than being only randomly captured images, some of which may not have turned out well due to an awkward pose or eyes being closed.

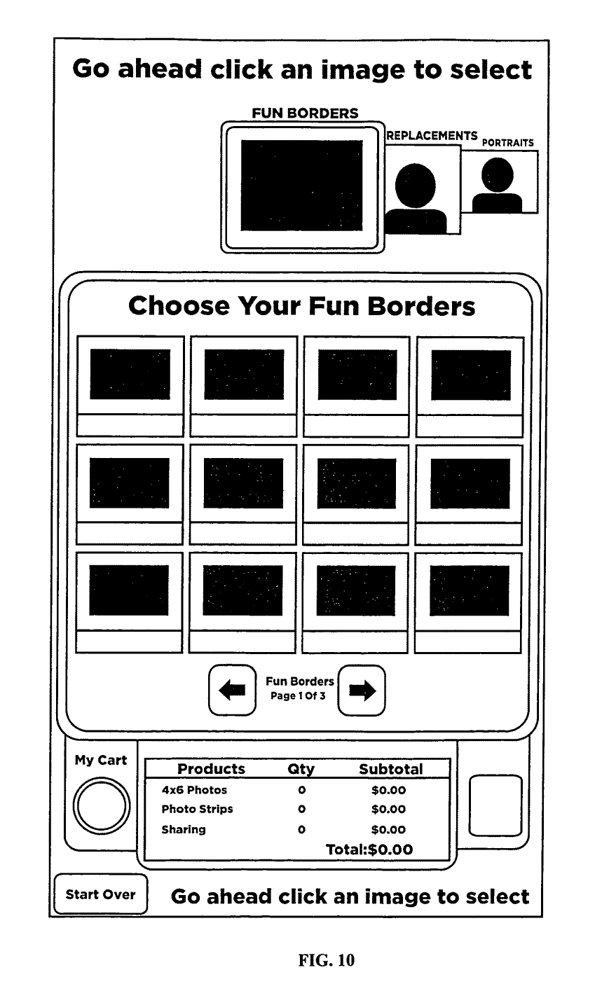

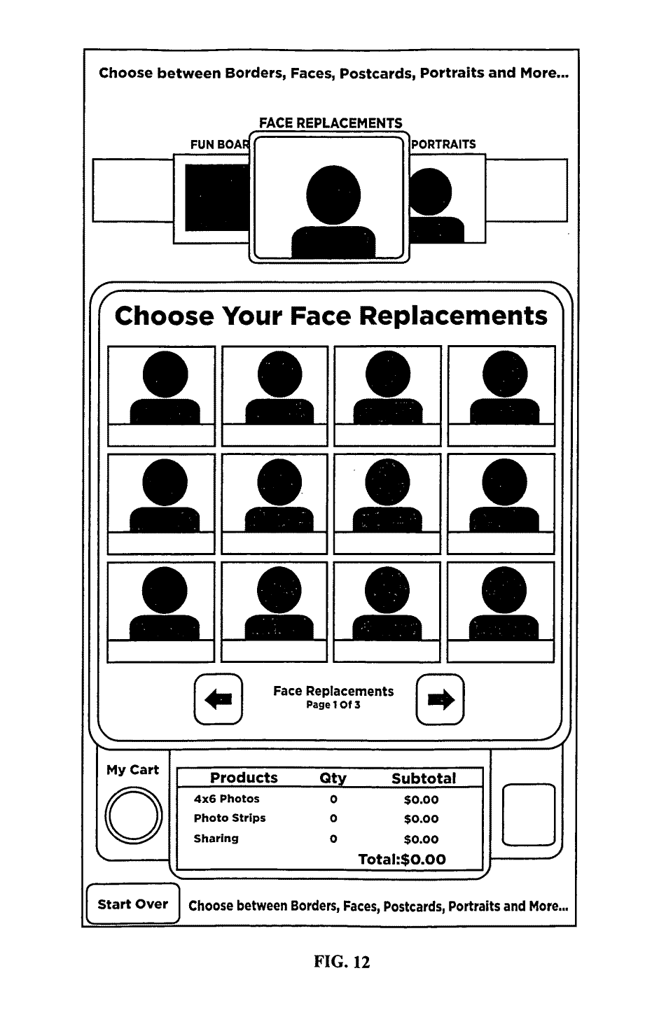

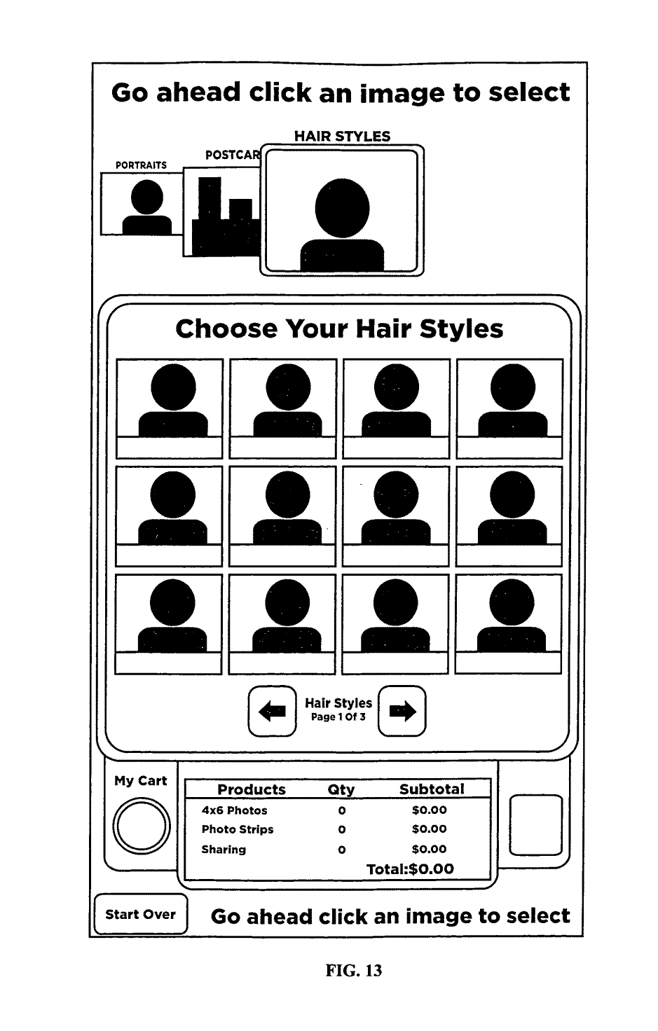

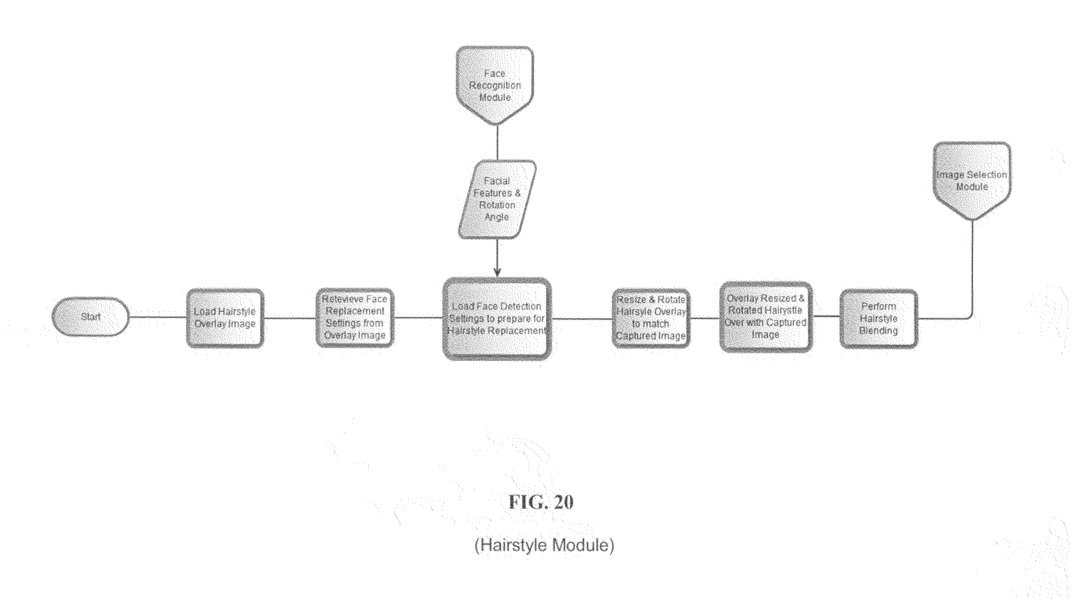

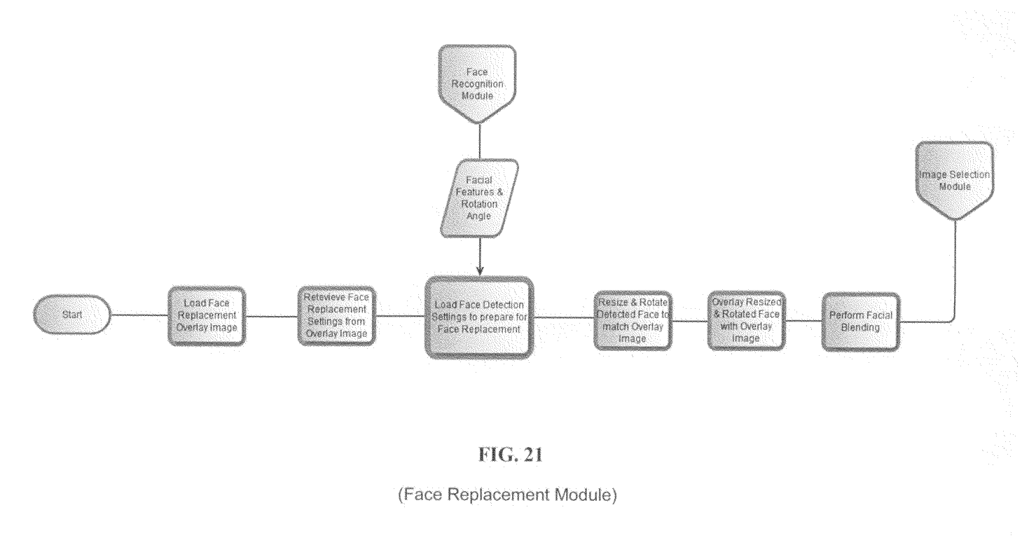

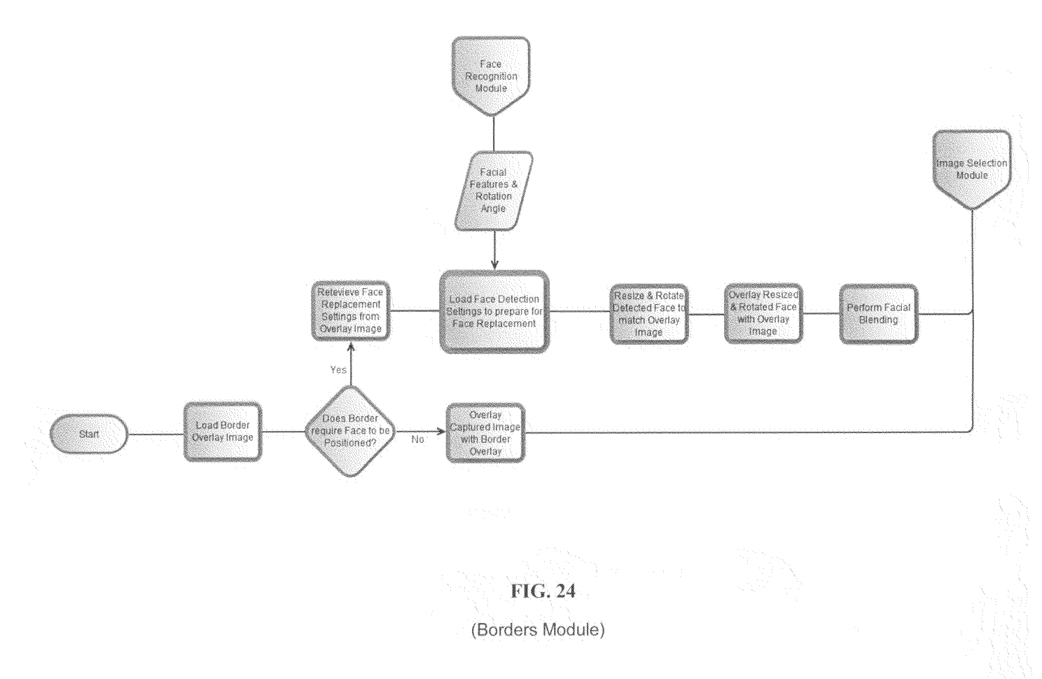

The photo booth 10 interior will feature a series of user controlled options for the paying patron. One of the options permits face replacement, whereby the user may place his or her face from the captured image onto somebody else's body, as seen in the face replacement module of FIG. 21, and in the screen shot showing the patron options in FIG. 12. The program for this option may permit filtering to allow adult users to utilize more suggestive or explicit imagery than the imagery available to children and teenagers. The replacement option may also feature the ability to substitute various different hair styles or wigs for the captured images, as seen in the hairstyles module of FIG. 20, and in the screen shot showing patron options in FIG. 13. The photo booth patron may also have the option to superimpose the photographic image onto various backgrounds, as seen in the borders module of FIG. 24, and the screen shot in FIG. 10. The background option may similarly have a filtering option permitting only the adult patrons to utilize more suggestive backgrounds. The background may be selectable from any applicable holiday scene, such as winter backgrounds for a personalized Christmas greeting card, or religious backgrounds for certain holidays or occasions, such as for Easter, First Communions, Bar Mitzvahs, Bas Mitzvahs, etc. The background may have themes for specialized patrons, such as scenes with the flag and military paraphernalia for photos directed toward U.S. Service men and women, or sporting scenes for high school and college athletes, etc. The themes may also be constructed to be humorous, such as with the “Wanted” poster background seen in FIG. 10.

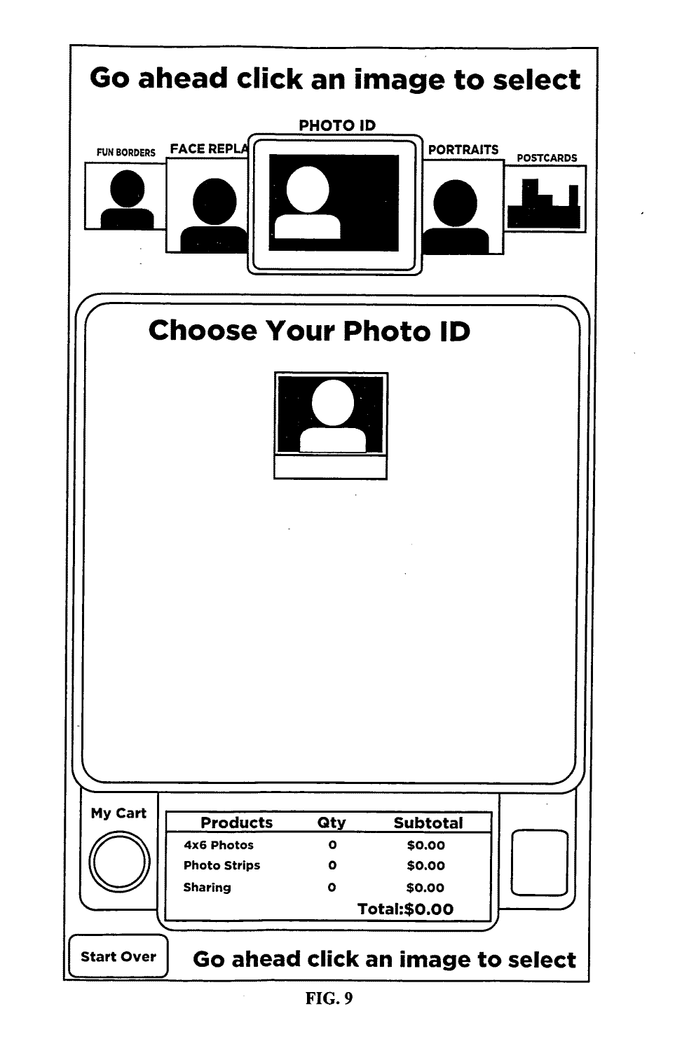

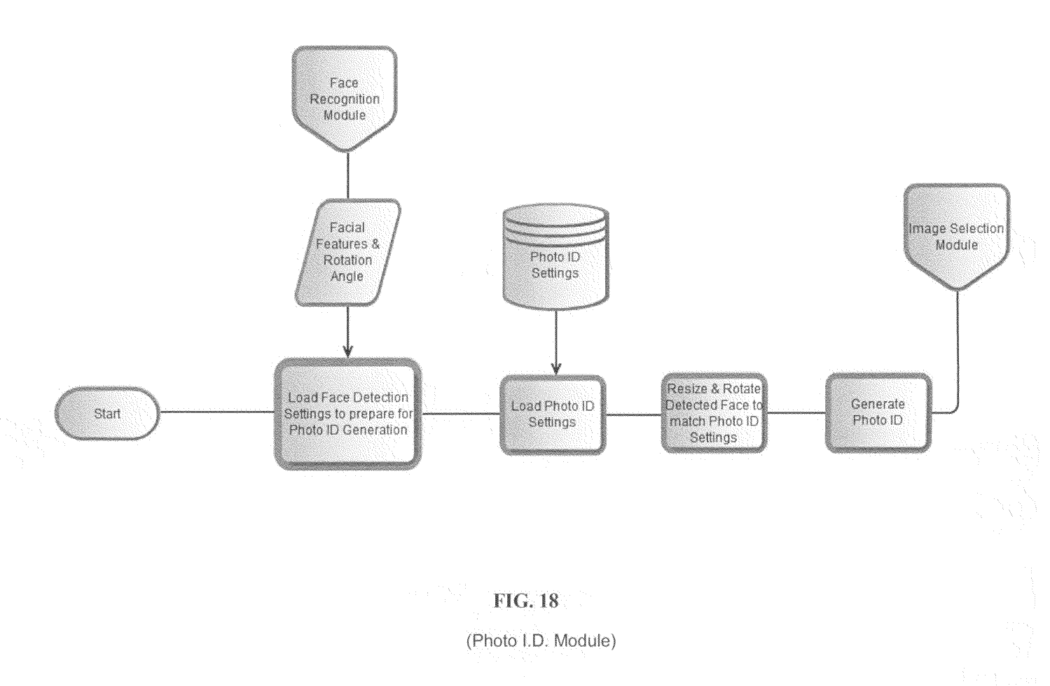

Another photographic option which may be produced by the current device is ID photographs, particularly passport photos, as seen in the photo I.D. module of FIG. 18, and the screen shot of FIG. 9. The requirements for passport photos are very specific, and different than would normally be desired for individuals or multiple people who were seeking to take a photo to commemorate a time period or event. Passport photographs must be 2×2 inches in size, there must be two identical photographs that were taken within the past 6 months, showing current appearance; they must be in color and include a front view of the full face with a plain white or off-white background. The photos must be between 1 inch and 1⅜ inches from the bottom of the chin to the top of the head. The passport applicant is supposed to be wearing street attire, as uniforms are not permitted, except religious attire that is worn daily. Also hats or headgear that obscures the hair or hairline are not to be worn. Glasses and hearing devices and wigs should be worn for the photo if they are normally worn by the user. A placard may be posted within the booth as to these requirements, or directions may appear on the LCD screen to assist the user.

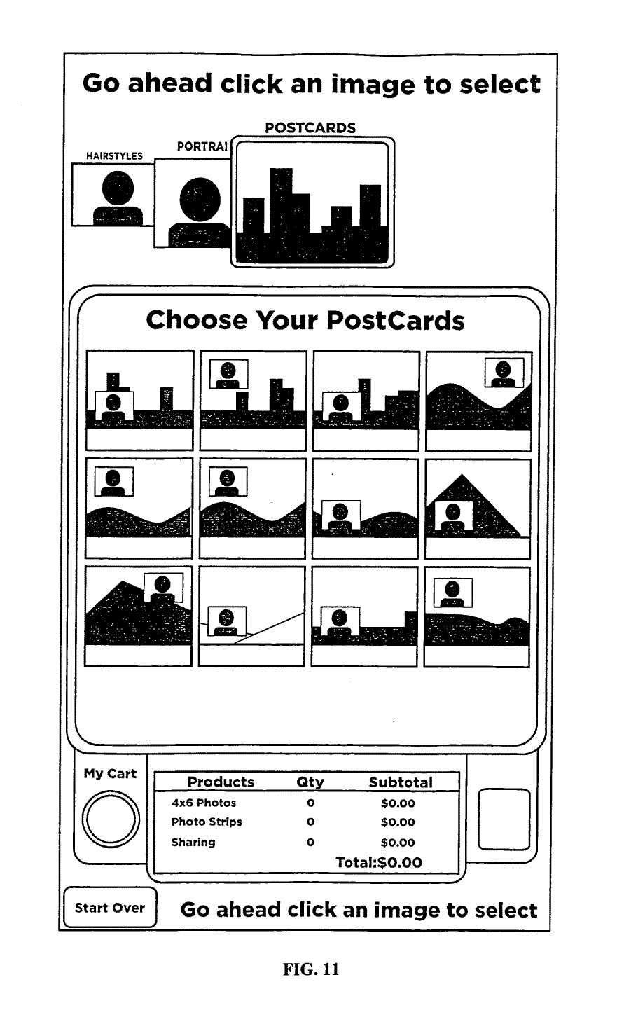

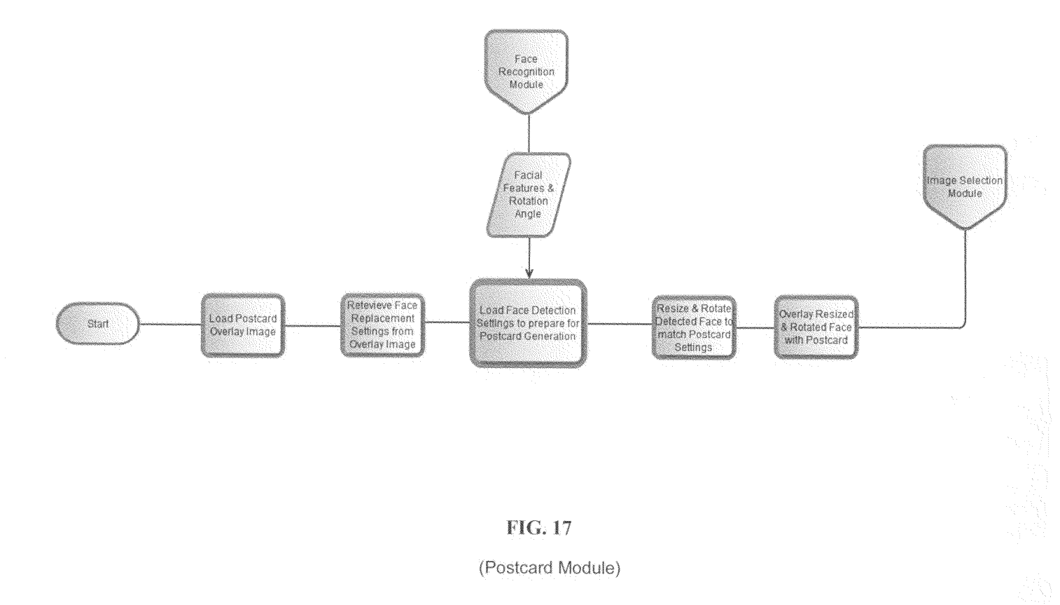

The device of the current invention may also offer a post card option, as seen in the post card module of FIG. 17, and in the screen shot in FIG. 11. This option will enable the user to superimpose his or her photographic image onto a background that displays tourist sites from all over the world, and produce a post-card suitable for mailing. It may also be desirable to have postcard backgrounds from many different sites within the city or region where the photo booth is located. People vacationing in Florida or California or other destinations can obtain not just a generic postcard from a gift shop, but one from the photo booth that has their current image incorporated into the scenic background of their vacation destination. This feature may also have filtering to prevent adult content in the postcard border from being utilized by younger patrons.

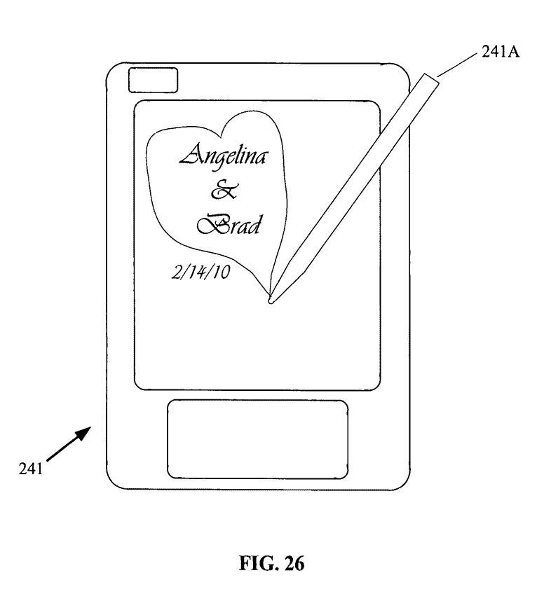

A very creative feature of the current invention permits the patron of the photo booth 10 to personalize the photographs by entering their own art work and notations. The device herein may comprise both a touch screen and a screen that is enabled just as a tablet PC 241 FIG. 26, where the user may write on the screen with a special pen 241A. The patron may thus personalize the photographic image before it is printed using the pen. The patron may, for example, sign their names or date the picture, or add a Valentine inscription or notation or other customization. There may also be a key board so that a typewritten caption or heading may be added to have a more formal appearance, as well as being able to insert text within the captured image itself.

The device of the current invention may also permit the personalized photographic output to be sent to a user's e-mail address. Thus, the unit may have internet capability. The keyboard, as previously mentioned, may permit the user to enter e-mail addresses. The keyboard may be a separate mechanical keyboard, or it may be a keyboard integrated into the touch screen of the invention, so that no additional hardware is required. In addition, the photo booth may provide the user with a serial number that is coded for the user's photo booth session, and thereby give the user the opportunity to make purchases at a later date, either at a later time while back at the kiosk, or while at home and shopping online. These subsequent purchases may simply be for photographed images, but may also be for other manufactured goods that use the image, such as coffee mugs and mouse pads with the images printed thereon. Also, the device may permit the user to interact and distribute the photographic output at the kiosk to social networking sites, such as Facebook and Twitter.

With the capabilities of the photo booth 10 of the current invention disclosed, the advantages of the interactive attract mode may be better discussed. As stated previously, the exterior of the kiosk may have a camera. The camera may, once a person has stopped, acquire a photographic image of the person or persons, and immediately superimpose it upon a large assortment of backgrounds, with substitutions for a person's hair and body, and with postcard options for the particular region where the booth is located. Altogether, there may be as many as one hundred different options programmed to appear on the monitor. This not only permits the potential patron to be exposed to the many possible options offered by the state of the art photo booth, but also to conduct a transaction without ever entering or touching the machine, except for the payment. The user may be told to press a red button outside of the booth to acquire other another pose (FIG. 2A).

The kiosk of the current invention, both for the inside seated purchaser and the outside standing patron, may also provide the option to select and purchase many different photo options all within a single transaction, which will tend to raise the revenue of such machines. Ordinarily, a photo booth requires a purchaser to pay for a single pose or a series of quick snapshots, where there is basically one payment and one single vend of a photo strip. This invention offer a more diversified and profitable means of selling to customers. For example, the patron of this invention may be able to select 3 or 4 different scenic color post card photos to mail to friends; various different poses for a strip of black and white photos; a pair of passport suitable photos; and a humorous 4×6 portrait where a body-builder's body or a supermodel's body has been overlaid thereon, all within a single transaction. The means to accept both cash and credit card payments at this photo booth further facilitates these multi-vend, higher-dollar transactions.

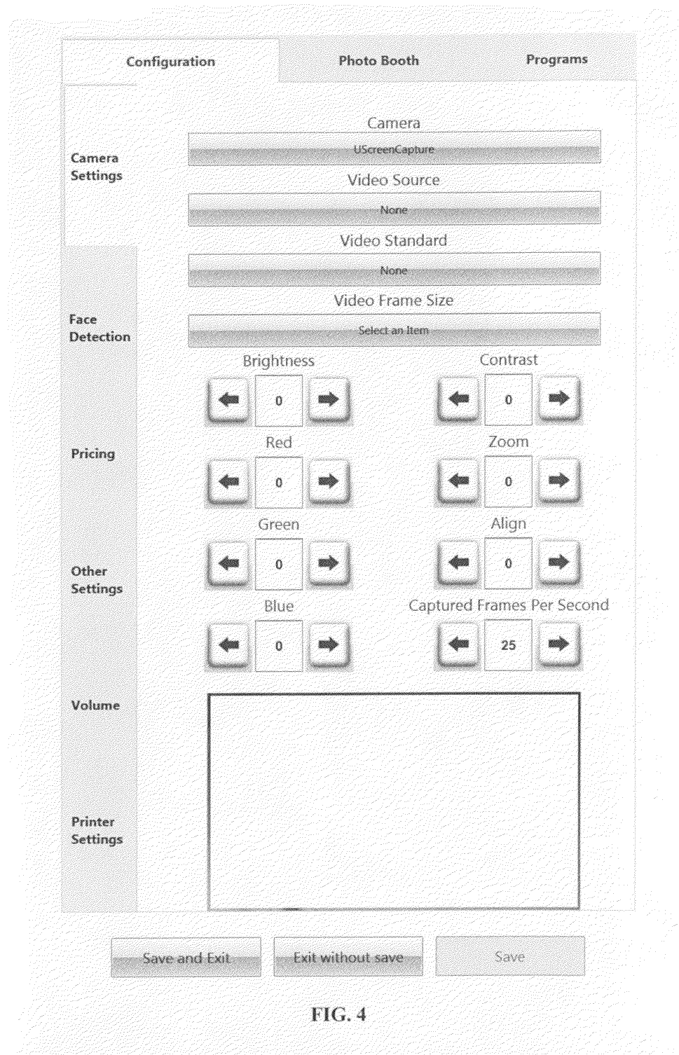

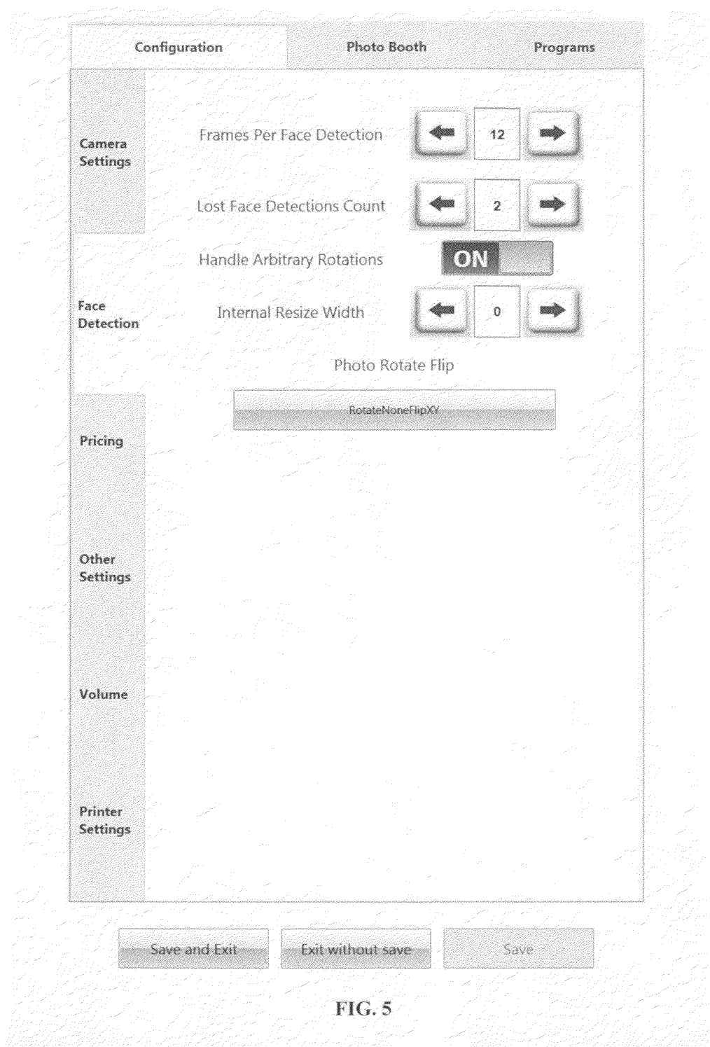

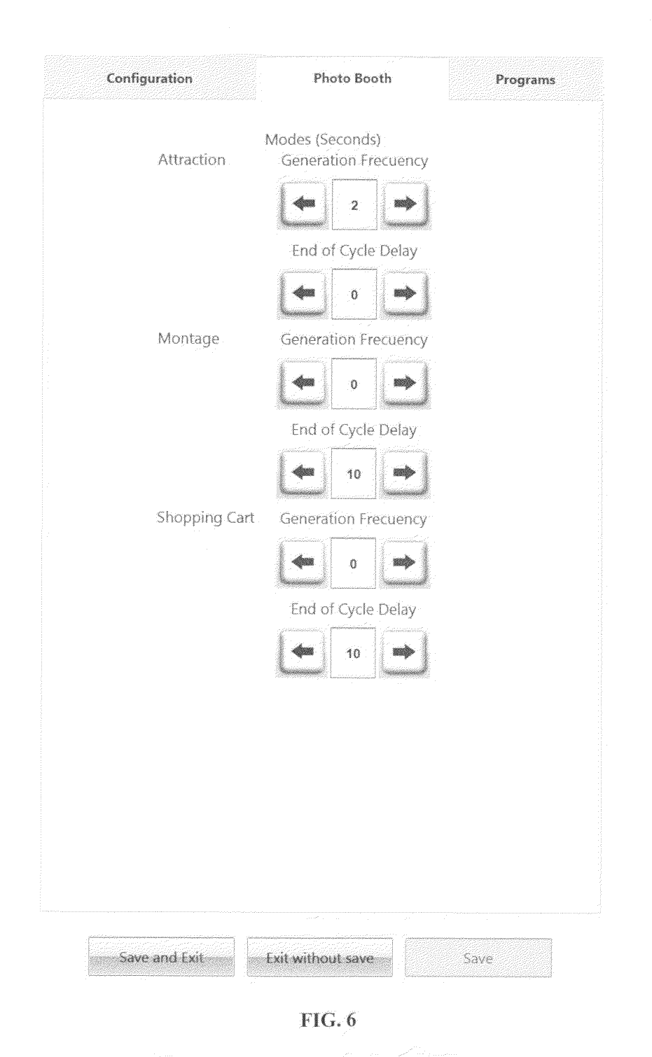

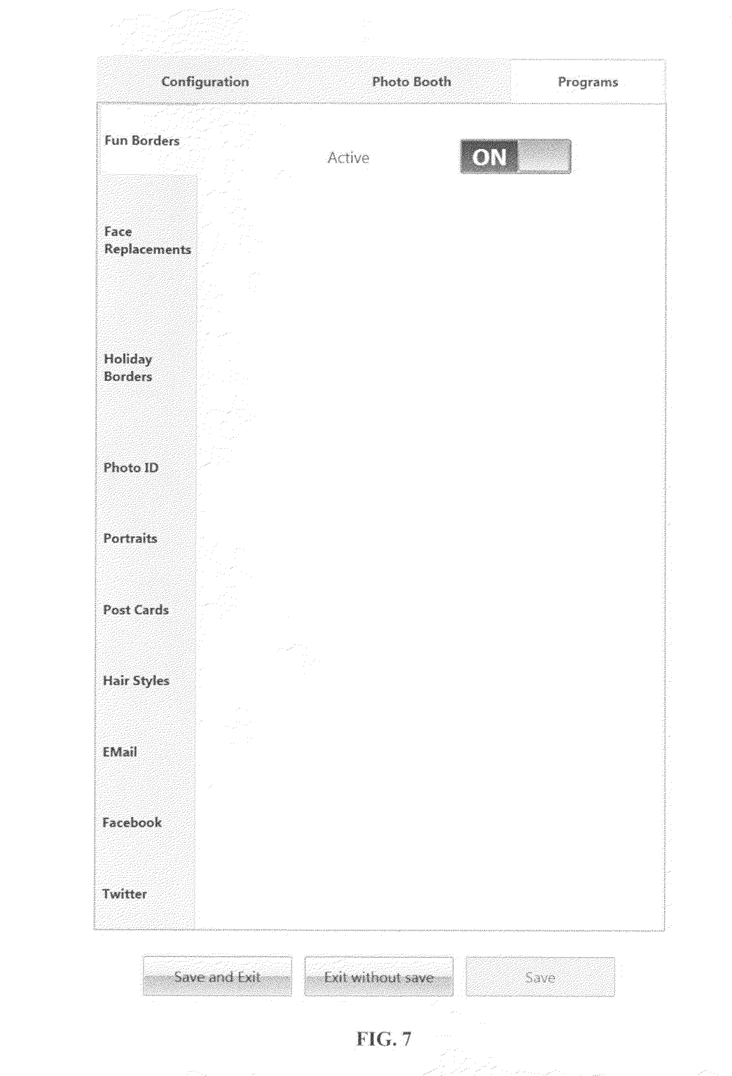

The device of the current invention will also permit the booth owner to have remote control over many of the features and overall operation of the photo booth. The device may permit the owner to make changes remotely, using the internet, to the configuration settings, including, but not limited to, the settings shown in FIGS. 4-7. This may include changing prices during peak holiday periods, or enabling/disabling features such as the e-mail option, or temporarily disabling the entire device by turning it off, and back on again at a later time, such as for when the booth might be patronized during normal business hours at a mall. The internet capability may include the ability of the device owner to receive an email alert from the photo booth when the booth is either in, or approaching, a distressed state, which may be when the unit is low on paper or ink, or has had a printer jam or other failure. The alerts may be periodic according to the setting chosen by the owner, and could be weekly, daily, or hourly alerts, which may be set by the owner based upon projected usage and the frequency of owner visitation to the photo booth site. The owner may be able to remotely vary the configuration. For example, the device may offer the owner the option of utilizing its multi-lingual capabilities to permit interaction with patrons in multiple languages. The configuration may also be changeable to alter the display settings in order to change the Attraction Modes. The owner may be able to upload newly developed background images, additional language options, and other special features.

Lastly, the device may also offer the kiosk owner many different accounting options, whereby the owner may be able to conduct individual online audits of each machine that he or she owns. This may include sales statistics. Since many cell phone service providers offer internet access on certain cell phones, the kiosk owner may be able to audit each machine through use of his cell phone 50, as seen in FIG. 2.

In an alternate embodiment, photo booth 10A, seen in FIG. 1A, may have a first exterior monitor 25A and a second exterior monitor 25B on the front wall 12, which permits simultaneous viewing, whereby a primary monitor may be used for photo booth applications, and the second monitor may be used for secondary functions. For example, Monitor 25A may be have the CATV connection to display news, sports, or other broadcasts, while monitor 24B may be used for displaying images of passersby or of an already enticed potential patron who has stopped to watch the news. The monitor 25B may therefore display the notice for the uncompensated outside printing in the “Free Mode: Printing” option previously discussed. Monitor 25A may also be utilized to display advertising, which may be general advertisement, or may be linked to retail sellers in the area who may desire such exposure. The advertising could be in many different forms, such as still slides, or a video ad, or a text crawl across the bottom of the screen that is displaying the news/sports.

The monitor 25B may also be advantageously utilized in the display of a continuous slide show of photos previously captured by the Photo Booth Application. This slide show may be shown on both the exterior monitors 25A/25B, as well as the interior monitor 24. The display could be live video rather than a slide show of previously captured video. Also, the side walls 15 of the kiosk may also have monitors located thereon to entice customers before such pedestrians have actually reached the point of passing by the kiosk where they would be able to see and appreciate the visual display on Monitors 25A/25B. The rear wall 16 may also include such a monitor and decorative art work, as the photo booth 10A need not be positioned against a wall of a building, and conversely, may be centrally situated within an open area, such as a shopping mall concourse.

The continuous slide show could also be transmitted, either wirelessly or through a wired connection, to be distributed to other kiosks through a distribution center, so that the same slide show may be displayed at numerous areas at a single time.

One other additional feature of photo booth 10A may be the use of motion detectors within the booth, that permit additional functionality, such as bright exterior lighting to indicate that one or more patrons are currently using the booth, to further draw attention to the kiosk and its popularity. The light 19, seen in FIGS. 1 and 2 on the top of the photo booth, may thus serve to attract such customers.

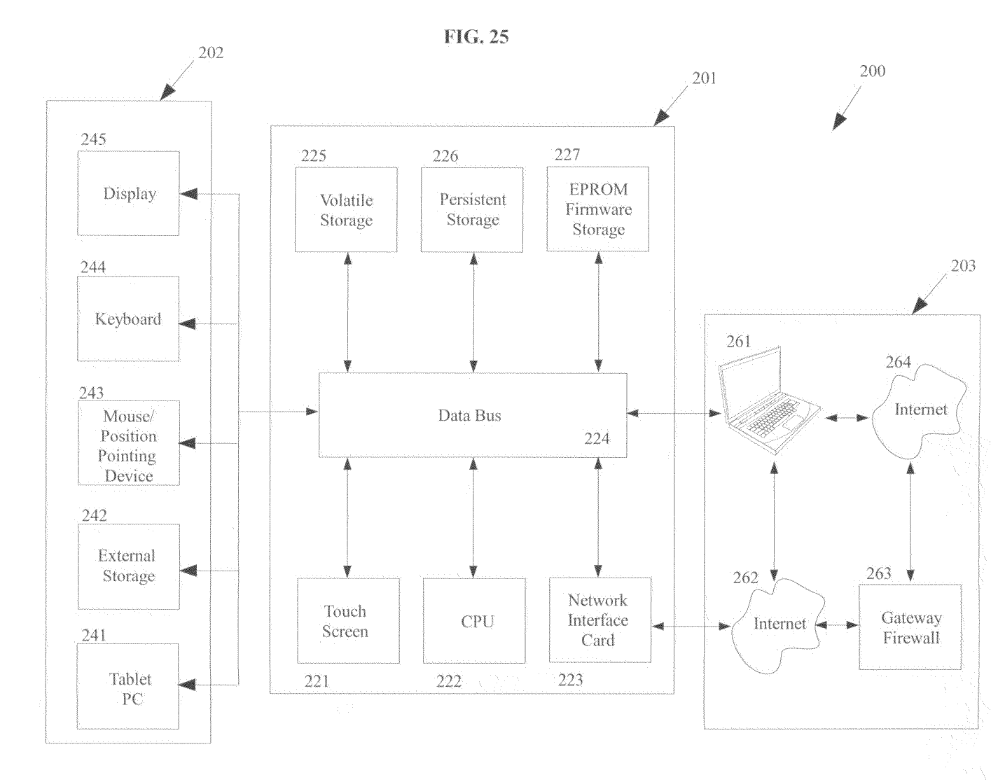

To properly enable the software utilized by the present invention, which may run on a computer or be accessed therefrom, a description of such a computer system is hereinafter disclosed. An exemplary computer system 200, which may provide a user with the services of the photo booth of the current invention, is shown schematically in FIG. 25, and may comprise a computing unit 201 of the photo booth interacting with external peripherals 202, such as a separate tablet P.C. 241, and interacting with network resources 203, including a remotely located user's PC 261, which may be a laptop computer. A complete exemplary computer system will be described for an understanding of how the photo booth software may interact with and on a computing unit 201, even though a particular embodiment involving usage of the software may not require each of the computer components described hereinafter.

The computing unit 201 may include a data bus 224 or other communication mechanism for communicating information across and among various parts of computing unit 201, and a central processing unit (“processor” or CPU) 222 coupled with a bus 224 for processing information and performing other computational and control tasks. Computing unit 201 may also include a volatile storage 225, such as a random access memory (RAM) or other dynamic storage device, coupled to bus 224 for storing various information as well as instructions to be executed by processor 222. The RAM may be Dynamic Random Access Memory (DRAM), or Static RAM (SRAM), or any other similar type of RAM known in the art. The volatile storage 225 also may be used for storing temporary variables or other intermediate information during execution of instructions by processor 222. Computing unit 201 may further include a read only memory (ROM) or an erasable programmable memory (EPROM) 227 or other static storage device coupled to bus 224 for storing static information and instructions for processor 222, such as basic input-output system (BIOS), as well as various system configuration parameters. A persistent storage device or non-volatile memory 226, such as a magnetic disk, optical disk, or solid-state flash memory device may be provided and may be coupled to bus 224 for storing information and instructions.

Computing unit 201 may be coupled via bus 224 to a touch screen display 221, such as a plasma display, or a liquid crystal display (LCD), for displaying information to a user of the computing unit 201. If desired, the computing unit 201 may also be coupled via bus 224 to an external display screen 245, which may further comprise a cathode ray tube (CRT). An external input device 244, including alphanumeric and other keys, may also be coupled to bus 224 for communicating information and command selections to processor 222. Another type of user input device is cursor control device 243, such as a mouse, a trackball, or cursor direction keys for communicating direction information and command selections to processor 222 and for controlling cursor movement on display 245, if desired. Also, a cursor control device 243 may also be utilized for the PC 261 of the network resources 203.

An external storage device 242 may be connected to the computing unit 201 via bus 224 to provide an extra or removable storage capacity for the computing unit 201. In an embodiment of the computer system 200, the external removable storage device 242 may be used to facilitate exchange of data with other computer systems.

According to one embodiment of the invention, the techniques described herein are performed by computing unit 201 in response to processor 222 executing one or more sequences of one or more instructions contained in the volatile memory 225. Such instructions may be read into volatile memory 225 from another computer-readable medium, such as persistent storage device or non-volatile memory device 226. Execution of the sequences of instructions contained in the volatile memory 225 causes processor 222 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 222 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 226. Volatile media includes dynamic memory, such as volatile storage 225. Transmission media includes coaxial cables, copper wire and fiber optics, including the wires that comprise data bus 224. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 222 for execution. For example, the instructions may initially be carried on a magnetic disk from a remote computer. Alternatively, a remote computer can load the instructions into its dynamic memory and send the instructions over a telephone line using a modem. A modem local to computer system 200 can receive the data on the telephone line. The bus 222 may carry the data to the volatile storage 225, from which processor 222 retrieves and executes the instructions. The instructions received by the volatile memory 225 may optionally be stored on persistent storage device 226 either before or after execution by processor 222. The instructions may also be downloaded into the computing unit 201 via Internet using a variety of network data communication protocols well known in the art.

The computing unit 201 may also include a communication interface, such as network interface card 223 coupled to the data bus 222. Communication interface 223 provides a two-way data communication coupling to a network link that may be connected to a local network 262. For example, communication interface 223 may be an integrated services digital network (ISDN) card or a modem to provide a data communication connection to a corresponding type of telephone line. As another example, communication interface 223 may be a local area network interface card (LAN NIC) to provide a data communication connection to a compatible LAN. Wireless links, such as the well-known 802.11a, 802.11b, 802.11g and Bluetooth may also used for network implementation. In any such implementation, communication interface 223 sends and receives electrical, electromagnetic or optical signals that carry digital data streams representing various types of information.

Network link 223 typically provides data communication to other network resources. For example, the network link may provide a connection through local network 262 to a host computer 261, or the computing unit 201 may connect directly to the host computer 261. Alternatively, the network link 223 may connect through gateway/firewall 263 to the wide-area or global network 264, such as an Internet. Thus, the computing unit 201 can access network resources located anywhere on the Internet 264. On the other hand, the computing unit 201 may also be accessed by others, with permission, and may be located anywhere on the local area network 262 and/or the Internet 264. The other users may themselves be operating a platform similar to computer system 200.

Local network 262 and the Internet both use electrical, electromagnetic or optical signals that carry digital data streams. The signals through the various networks and the signals on network link and through communication interface 262, which carry the digital data to and from computing unit 201, are exemplary forms of carrier waves transporting the information.

Computing unit 201 may be able to send messages and receive data, including program code, through the variety of network(s) including the Internet 264 and LAN 262, network link and communication interface 233. In the Internet example, when the computing unit 201 acts as a network server, it might transmit a requested code or data for an application program running on PC 261 through the Internet 264, gateway/firewall 263, local area network 262 and communication interface 223. Similarly, it may receive code from other network resources.

The received code may be executed by processor 222 as it is received, and/or stored in persistent or volatile storage devices 226 and 225, respectively, or other non-volatile storage for later execution. In this manner, computer system 200 may obtain application code in the form of a carrier wave.

The examples and descriptions provided merely illustrate a preferred embodiment of the present invention. Those skilled in the art and having the benefit of the present disclosure will appreciate that further embodiments may be implemented with various changes within the scope of the present invention. Other modifications, substitutions, omissions and changes may be made in the design, size, materials used or proportions, operating conditions, assembly sequence, or arrangement or positioning of elements and members of the preferred embodiment without departing from the spirit of this invention.

We claim:

1. A photo booth comprising:
an enclosure;
a camera within said enclosure for capturing one or more images therein;
a device to print said captured image upon a substrate;
an attraction means for inducing one or more passers-by to patronize said photo booth, said attraction means comprising:
a motion detector for detecting said one or more passers-by; and
interactive communication with said detected one or more passers-by to induce said patronage.

2. The photo booth according to claim 1, wherein said interactive communication comprises a speaker to output a greeting to said one or more passers-by.

3. The photo booth according to claim 2 further comprising a camera for capturing an image of said one or more passers-by entering within a range of said motion detector; and wherein said captured image of said one or more passers-by is displayed on a screen on an exterior surface of said enclosure.

4. The photo booth according to claim 3 further comprising one or more processors to execute instructions retained in machine-readable media to perform at least some portion of the following steps; and wherein said captured images comprise digital images, and said instruction providing for image processing for automatic tilting of a head in said captured image of said one or more passers-by on said display, regardless of a position of said head in said captured image.

5. The photo booth according to claim 4, wherein said instructions provide for displaying of a variety of poses on said screen from a single captured image.

6. The photo booth according to claim 5, wherein said attraction means comprises storing said captured image of said one or more passers-by in a memory, said instructions accomplishing facial recognition of one or more returning passers-by re-entering said range of said motion sensor by comparing a captured image with said stored images, said instructions causing modification of said greeting for said returning one or more passers-by to be a personalized greeting.

7. The photo booth according to claim 6, wherein said interactive communication further comprises one or more of: aural directions, textual directions, product options, and a sales pitch.

8. The photo booth according to claim 7, wherein said attraction means further comprises a second exterior display screen; said second screen being usable for displaying one or more of advertising, and a CATV broadcast.

9. The photo booth according to claim 8, wherein said advertising comprises one or more of: a slide show, a live telecast, and a pre-recorded video.

10. The photo booth according to claim 9, wherein said first exterior display screen comprises a touch screen; and wherein said instructions permits said one or more passers-by to customize a respective digital image using said touch screen by applying special effects.

11. The photo booth according to claim 10, wherein said special effects comprise one or more of: face replacement; hair replacement; and background selection.

12. The photo booth according to claim 11, wherein said attraction means comprises offering a free sample photograph of said non-customized image of said one or more passers-by.

13. The photo booth according to claim 12 further comprising an interior touch screen display being within said enclosure, said interior touch screen permitting a patron to customize a digital image captured therein by applying said special effects.

14. The photo booth according to claim 13, wherein said touch screen permits previewing of an image in a desired output size and a color choice.

15. The photo booth according to claim 14, wherein said desired output size comprises one or more of a two inch by two inch passport photo, a postcard, and a standard photographic print size; and
wherein said color choice comprises one or more of: black and white output, and colorized output.

16. The photo booth according to claim 15 further comprising a button; and wherein pushing said button causes said camera to capture a second image when said previewed image is unsatisfactory.

17. The photo booth according to claim 16, wherein said instruction comprise a multi-lingual capability, said multi-lingual capability permitting said directions to be available in one or more languages.

18. The photo booth according to claim 17, wherein said interior display comprises a tablet PC to permit artwork and text to be added to said printed image.

19. The photo booth according to claim 18, wherein said art work and text added to said image is added by one or more of: handwriting on said screen of said tablet PC using a pen, and making keyboard entries.

20. The photo booth according to claim 19, wherein said attraction means comprises an interior motion detector, said interior motion detector triggering bright exterior lighting upon detecting a patron within said enclosure.

21. The photo booth according to claim 20 further comprising an internet connection; and wherein said internet connection permits one or more of: e-mailing of said images, and sending said images to an online social network.

22. The photo booth according to claim 20, wherein a corresponding serial number is displayed with said images; and wherein said corresponding serial number permits a subsequent purchase at a later date, said subsequent purchase being one or more of: a purchase at said photo booth, and an internet purchase.

23. The photo booth according to claim 22 further comprising a remote control capability; said remote control capability permitting one or more of: remotely changing prices, remotely enabling or disabling one or more of said special effects, remotely turning said photo booth on or off, remotely receiving alerts of a distressed state of said photo booth, remotely changing said attraction mode, and remotely performing an audit of captured images and purchases at said photo booth.

24. A photo booth comprising:
an enclosure;
a digital camera within said enclosure for capturing one or more digital images therein;
a device to print said captured image upon a substrate; and
an attraction means for inducing one or more passers-by of said photo booth to patronize said photo booth, said attraction means comprising:
a screen on an exterior surface of said enclosure; and
a camera for capturing an image of said one or more passers-by, said captured image of said one or more passers-by being selectively displayed on said screen.

25. The photo booth according to claim 24 further comprising one or more processors to execute instructions retained in machine-readable media to perform at least some portion of the following steps; and wherein said selective display comprises said instructions permitting image processing for automatic tilting of a head in said captured image of said one or more passers-by on said display, regardless of a position of said head in said captured image.

26. The photo booth according to claim 25, wherein said instructions provide for displaying of a variety of poses from a single captured image.

27. The photo booth according to claim 26 further comprising a motion detector for detecting said one or more passers-by entering within a range of said motion detector; and wherein said attraction means comprises interactive communication with said detected one or more passers-by to induce said patronage.

28. The photo booth according to claim 27, wherein said interactive communication comprises a speaker to output a greeting to said one or more passers-by.

29. The photo booth according to claim 28, wherein said attraction means comprises storing said captured image of said one or more passers-by in a memory, said instructions accomplishing facial recognition of one or more returning passers-by re-entering said range of said motion sensor by comparing a captured image with said stored images, said instructions causing modification of said greeting for said returning one or more passers-by to be a personalized greeting.

30. The photo booth according to claim 29, wherein said interactive communication further comprises one or more of: aural directions, textual directions, product options, and a sales pitch.

31. The photo booth according to claim 24, wherein said display screen comprises a touch screen; and
wherein said instructions permit said one or more passers-by to customize a respective digital image using said touch screen by applying special effects.

32. The photo booth according to claim 31, wherein said special effects comprise one or more of: face replacement; hair replacement; and background selection.

33. The photo booth according to claim 32 further comprising a remote control capability; said remote control capability permitting one or more of: remotely changing prices, remotely enabling or disabling said special effects, remotely turning said photo booth on or off, remotely receiving alerts of a distressed state of said photo booth, remotely changing said attraction mode, and remotely performing an audit of said photo booth.

34. The photo booth according to claim 24 further comprising an internet connection; and wherein said internet connection permits one or more of e-mailing said images, and loading said images on a social network.

35. The photo booth according to claim 24, wherein a corresponding serial number is displayed with said images; and wherein said corresponding serial number permits a subsequent purchase at a later date, said subsequent purchase being one or more of: a purchase at said photo booth, and an online purchase.

36. The photo booth according to claim 24, wherein said attraction means comprises offering a free sample photograph of said captured image of said one or more passers-by.

37. The photo booth according to claim 24, wherein said attraction means comprises a second exterior display screen; said second screen being usable for displaying one or more of: advertising, and a CATV broadcast.

38. The photo booth according to claim 37, wherein said advertising comprises one or more of: one or more slide shows, one or more live telecasts, and one or more pre-recorded videos.

39. The photo booth according to claim 38 further comprising a touch screen display within said enclosure, said interior touch screen permitting a patron to customize a digital image captured therein by applying special effects; and wherein said special effects comprise one or more of: face replacement; hair replacement; and background selection.

40. The photo booth according to claim 39, wherein said touch screen permits previewing of an image in a desired output size and a color choice.

41. The photo booth according to claim 40, wherein said desired output size comprises one or more of: a two inch by two inch passport photo, a postcard, and a standard photographic print size; and wherein said color choice comprises one or more of: black and white output, and colorized output.

42. The photo booth according to claim 41 further comprising a button to capture a second image when said previewed image is unsatisfactory.

43. The photo booth according to claim 31, wherein said instructions comprise a multi-lingual capability, said multi-lingual capability permitting said directions to be in one or more different languages.

44. The photo booth according to claim 39, wherein said display within said photo booth comprises a tablet PC to permit artwork and text to be added to said printed image.

45. The photo booth according to claim 44, wherein said art work and text added to said image is added by one or more of: handwriting on said screen of said tablet PC using a pen, and making keyboard entries.

46. A photo booth comprising:
an enclosure;
a digital camera within said enclosure for capturing one or more digital images therein;
a tablet PC comprising a memory and one or more processors to execute instructions retained in machine-readable media to perform at least some portion of the following steps; said tablet of said tablet PC permitting artwork and text to be added to said captured image to personalize said captured image; and
a device to print said personalized image upon a substrate.

47. The photo booth according to claim 46, wherein said art work and text is added to said captured image by one or more of: handwriting on said screen of said tablet PC using a pen, and making keyboard entries.

48. The photo booth according to claim 47 further comprising an attraction means for inducing one or more passers-by to patronize said photo booth, said attraction means comprising:
a motion detector for detecting said one or more passers-by; and
interactive communication with said detected one or more passers-by to induce said patronage, said interactive communication comprising a speaker to output a greeting to said one or more passers-by.

49. The photo booth according to claim 48 further comprising a camera for capturing an image of said one or more passers-by entering within a range of said motion detector; and wherein said captured image of said one or more passers-by is displayed on a screen on an exterior surface of said enclosure.

50. The photo booth according to claim 49, wherein said attraction means comprises storing said captured image of said one or more passers-by in a memory, said instructions accomplishing facial recognition of one or more returning passers-by re-entering said range of said motion sensor by comparing a captured image with said stored images, said instructions causing modification of said greeting for said returning one or more passers-by to be a personalized greeting.

51. The photo booth according to claim 50 and wherein said display screen comprises a touch screen;
further comprising a second touch screen display being within said enclosure; and wherein said instructions permit said one or more passers-by to customize a respective digital image using said touch screen by applying special effects; and wherein said special effects comprise one or more of: face replacement; hair replacement; and background selection.

52. The photo booth according to claim 51 further comprising an internet connection; and wherein said internet connection permits one or more of: e-mailing of said images, and sending said images to an online social network.

53. The photo booth according to claim 52, wherein a corresponding serial number is displayed with said images; and wherein said corresponding serial number permits a subsequent purchase at a later date, said subsequent purchase being one or more of: a purchase at said photo booth, and an online purchase.

54. The photo booth according to claim 53 further comprising a remote control capability; said remote control capability permitting one or more of: remotely changing a price, remotely enabling or disabling one or more of said special effects, remotely turning said photo booth on or off, remotely receiving alerts of a distressed state of said photo booth, remotely changing said attraction mode, and remotely performing an audit of said photo booth.
